(19) United States
(12) Patent Application Publication
(10) Pub. No.: US 2014/0246255 A1
(43) Pub. Date: Sep. 4, 2014

(54) PRODUCT CONTAINER WITH PRODUCT INFORMATION INDICATION

(71) Applicant: Daniel V. Semeniuta, Coto de Caza, CA (US)

(72) Inventor: Daniel V. Semeniuta, Coto de Caza, CA (US)

(21) Appl. No.: 13/783,123

(22) Filed: Mar. 1, 2013

(51) Int. Cl. G01G 19/40

(52) U.S. Cl. CPC G01G 19/40
USPC 177/1; 177/25.14; 177/25.16

(57) ABSTRACT

A product container configured to notify or indicate to a user information about a product contained therein. The container has a body defining a volume within for holding the product. A transparent material or light is coupled with the body for permitting a user to determine an amount of the product contained within the body. Markings or other printing may be disposed on or adjacent to the transparent material or light. The container additionally or alternatively has a sensor in communication with a processor for sensing a characteristic of the product. The processor is connected with an indicator coupled to the body for indicating information about the product based upon the sensed characteristic of the product. The processor may interface with a remote device via wired or wireless data transmission.

### BACKGROUND

1. Field

The present invention relates generally to product containers. More particularly, the present invention relates to food storage containers or boxes capable of displaying, notifying or indicating to a user an amount or other information about the food or product contained therein.

2. Description of the Related Art

Generally, families or individuals go shopping for groceries or other products at least once a week. Before making a trip to the supermarket or store, an inventory of items that are needed or almost needed must be taken so that the shopper is aware of the products that should be purchased. Certain items whose remaining amounts are plainly visible (e.g., paper towels, toothpaste, etc.) make inventory-taking easy since the shopper can identify the amount of product that remains in order to ascertain whether it is time to purchase more. However, when food or other products are contained within product containers that are made of a solid material, the user must go through the inconvenient process of opening each of the relevant containers or otherwise manipulate them in an attempt to learn how much product remains inside. This not only results in uncertainty and purchases that may not be necessary, but also is an inconvenience and undesirable expenditure of time.

In addition, as society becomes more concerned with health and fitness, diet and portion control have begun playing an increased role in the preparation of food at mealtimes. Calorie counting and other means of portion monitoring have become a daily ritual for many individuals in an effort to lose weight or to otherwise live a healthier lifestyle. Food producers, recognizing this shift in consumer desires, have begun packaging food items with predetermined amounts of calories in an effort to ease the burden on consumers who would otherwise have to calculate or measure the amount of the food item themselves. This extra convenience provided to the user can yield increased sales for the food producer. However, since predetermined calorie packages are usually only counted out for a single serving, extra packaging must be utilized in order to individually wrap the food into the predetermined calorie counts for consumer consumption. This produces more trash that is disposed of in landfills, raises costs for the food packager, and does not accommodate foods that are typically provided to consumers in amounts greater than a small serving size.

Thus, an improved food or other product container that is capable of providing a display, notification or indication to a user of information about the product, such as an amount of the product remaining within the container, is desired. The food or product container would desirably function to visually or otherwise indicate to a user easily and conveniently when the product within is low and should be replaced. The food or product container may also desirably communicate with other devices or receive input from a user in order to conveniently supply the user with desired information about the product inside.

### SUMMARY

A product container having notification or identification capabilities to alert a user to information about the product is disclosed. In one embodiment, a container may include a body defining a cavity for containing a product, the body having a surface defining an opening and a light coupled with the body and configured to illuminate based upon proximity of the product in the cavity to the light.

In another embodiment, a container may include a body defining a volume therein for holding a product, a sensor coupled with the body for sensing a characteristic of the product, a processor coupled with the body and configured to interface with the sensor, and an indicator coupled with the body and configured to interface with the processor for indicating information about the product based on the characteristic of the product sensed by the sensor.

In yet another embodiment, a method for indicating to a user information about a product contained in a container, the method comprising the steps of, sensing a characteristic of the product at a processor, determining, using the processor, an amount of the product contained in the container based on the sensed characteristic of the product, determining a display characteristic for indicating to the user the amount of the product contained in the container, and indicating to the user the amount of the product contained in the container based on the display characteristic.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1A shows a perspective view of a product container having a visual indication including a transparent material for indicating an amount of product contained therein, according to an embodiment of the present invention;

FIG. 1B shows a perspective view of a product container having a visual indication including a plurality of lights for indicating an amount of product contained therein, according to an embodiment of the present invention;

FIG. 2 shows a block diagram of a system using electronic components for providing a notification to a user of information about a product contained within a product container, according to an embodiment of the present invention;

FIG. 3 shows a perspective view of a product container using electronic components to provide a visual indication of information about a product contained therein, according to an embodiment of the present invention;

FIG. 4 shows a perspective view of a product container using electronic components to interface with a second device for providing an indication of information about a product contained within the product container, according to an embodiment of the present invention; and

FIG. 5 shows a flowchart of a method for indicating to a user information about a product contained within a product container, according to an embodiment of the present invention.

### DETAILED DESCRIPTION

The detailed description of exemplary embodiments herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

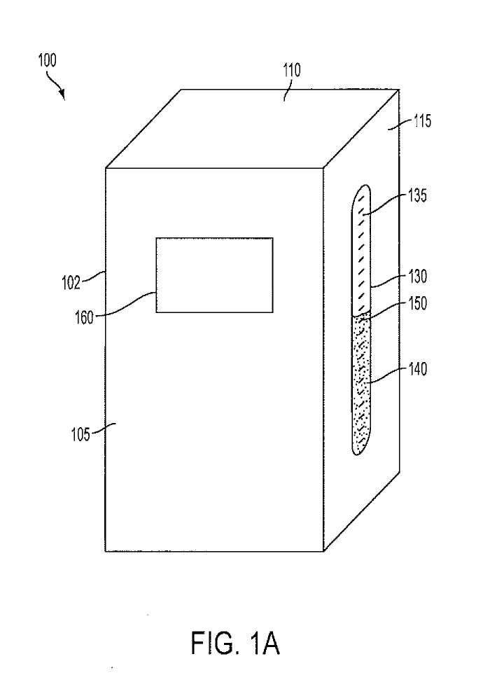

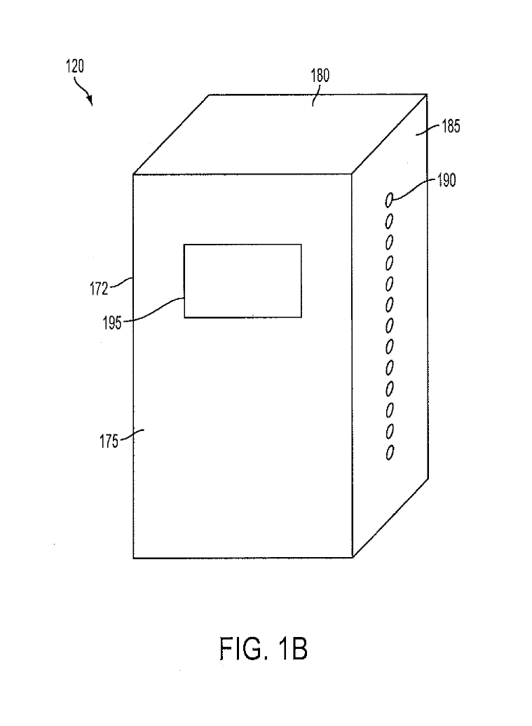

Turning first to FIG. 1A, a perspective view 100 of a product container or body 102 having a visual indication including a transparent material is shown. The product container or body 102 contains a volume therein for holding or containing an amount of a product. The product container 102 may be a food container (e.g., a cereal box) or any other type of food container or non-food container that is capable of holding a volume of a product within. As shown, the product container 102 has a front surface 105, a top surface 110, and a first side surface 115. A label 160 or other printing may be disposed upon the front surface 105 to indicate the type of product within the product container 102. While not visible in FIG. 1A, the product container 102 may also have a rear surface opposing the front surface 105, a bottom surface opposing the top surface 110, and a second side surface opposing the first side surface 115. In an alternative embodiment, any of a variety of surfaces, shapes, or other forms or configurations of the product container 102 may be utilized. Moreover, the label 160 or other printing may be disposed on any of the variety of surfaces, shapes, or other forms or configurations of the product container 102 or may be omitted completely.

A visual indicator 130 is coupled with the first side surface 115 of the product container 102. The visual indicator 130 may be a transparent material or a semi-transparent material covering an opening in or defined by the first side surface 115 in order to permit a person to view inside the product container 102 and see the contents therein. The transparent material of the visual indicator 130 may include markings 150 printed thereon to aid the person viewing inside the product container 102 in determining an amount or level of product disposed therein. In an alternative embodiment, the markings 150 may be printed on the product container 102 itself (e.g., adjacent to the visual indicator 130 on the first side surface 115).

Thus, the person viewing the product container 102 can determine the amount of product within by looking through the transparent material of the visual indicator 130 and examining the level of product. As shown, a top portion 135 of the visual indicator 130 shows that no product exists inside the product container 102 at that level while a bottom portion 140 of the visual indicator 130 shows that product exists inside the product container 102 at its level. The markings 150 may further aid the person by providing information such as percentages of product remaining, servings left of the product remaining, calories left of the product remaining, etc.

Although the visual indicator 130 is shown in FIG. 1A as an elongated window or transparent material on the first side surface 115 of the product container 102, alternative embodiments may use a window, transparent material, or semi-transparent material of any shape or configuration and/or may be disposed on any of the surfaces of the product container 102. As discussed in greater detail herein, alternative embodiments may include additional or replacement components for the visual indicator 130 for indicating or notifying a user as to a level or amount of product contained within the product container 102.

FIG. 1B, similar to FIG. 1A, shows a perspective view 120 of a product container or body 172 having a visual indication including illumination of lights. The product container or body 172 may include the same or similar features as previously discussed. The product container or body 172 contains a volume therein for holding or containing an amount of a product. The product container 172 may be a food container or any other type of food container or non-food container (e.g., a Tupperware or plastic container) that is capable of holding a volume of a product within. As shown, the product container 172 has a front surface 175, a top surface 180, and a first side surface 185. A label 195 or other printing may be disposed upon the front surface 175 to indicate the type of product within the product container 172. While not visible in FIG. 1B, the product container 172 may also have a rear surface opposing the front surface 175, a bottom surface opposing the top surface 180, and a second side surface opposing the first side surface 185. In an alternative embodiment, any of a variety of surfaces, shapes, or other forms or configurations of the product container 172 may be utilized. Moreover, the label 195 or other printing may be disposed on any of the variety of surfaces, shapes, or other forms or configurations of the product container 172 or may be omitted completely.

A plurality of indicators 190 (e.g., lamps, light-emitting diodes, etc.) are coupled with the first side surface 185 of the product container 172. Any number of indicators 190 may be used, including only one indicator. Each of the plurality of indicators 190 is configured to illuminate or turn on based on the level or amount of product that is currently contained within the product container 172, for example, in conjunction with a level sensor, weight sensor, light sensor or distance sensor that determines how the product is disposed in relation to each of the respective indicator 190 within the product container 172.

The sensing of light or distance may be determined by components included as part of each of the plurality of indicators 190. For example, when the product container 172 has an amount or level of product contained within that is higher than all of the plurality of indicators 190, each of the plurality of indicators 190 would be illuminated or turned on. As the product is consumed and its amount or level is diminished within the product container 172, certain of the plurality of indicators 190 would begin turning off as the product drops below their respective position on the product container 172. Thus, a user may quickly glance at the product container 172 without opening it and ascertain the amount or level of product contained within based upon the status of the plurality of indicators 190 that are illuminated. In an alternative embodiment, the plurality of indicators 190 may operate in an opposite fashion (i.e., illuminate or turn on when no product is disposed at an adjacent location). In still another embodiment, each of the plurality of indicators 190 may be turned on or off, not based upon the amount of product, but in response to another signal (e.g., from a processor) as discussed in greater detail herein.

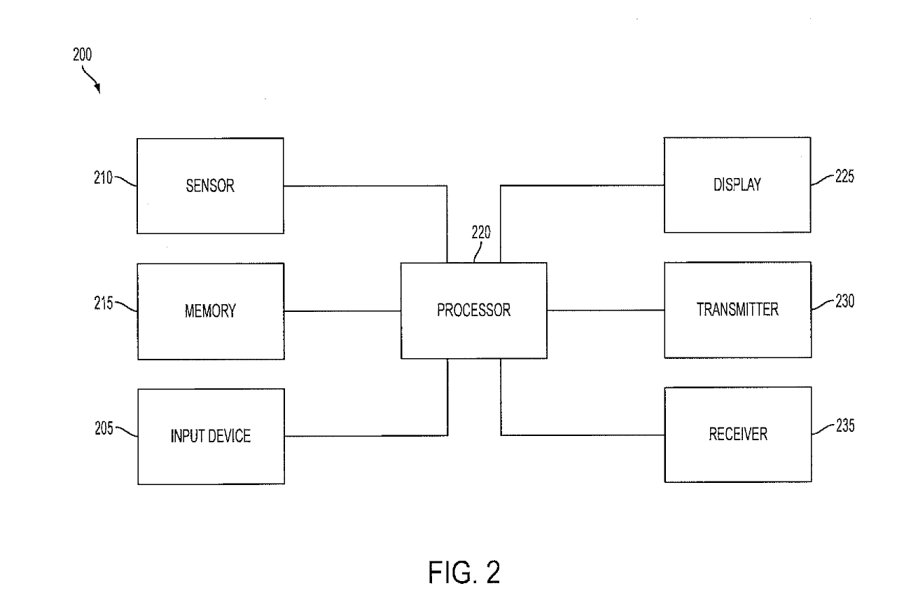

Turning next to FIG. 2, a block diagram 200 is shown of a system using electronic components for providing an indication or a notification to a user regarding a product contained within a product container. The product container may include the same or similar features as previously discussed. The product container includes a sensor 210 connected with a processor 220, the sensor configured to sense a characteristic of the product. In one embodiment, the sensor 210 may be positioned on an inside of the product container (e.g., on a bottom surface within the product container) and configured to detect a weight of the product that is currently contained within the product container. In another embodiment, the sensor 210 may be any of a variety of sensor types for detecting one or more characteristics of the product contained within the product container and be positioned at any of a variety of positions along or in the product container. For example, the sensor 210 may be configured to detect an amount of ambient light within the product container or may be configured to detect a distance between a component of the sensor to the product within the product container.

A processor 220 communicates or interfaces with the sensor 210 for determining information about the product contained within the product container. A memory 215 is also connected to the processor 220 for storing data. An input device 205 may be connected with the processor 220 in order to command or aid the processor 220 in determining what data stored in the memory 215 should be used. For example, the sensor 210 may be a sensor configured to determine a weight of the product currently contained within the product container. The memory 215 may store (e.g., in a table or database) data that correlates weight of a number of different product types to an amount of space that the respective different products would physically occupy within the container (e.g., volume, amount of product container it would fill, percentage of product container it would fill, etc.).

The input device 215 may send a signal to the processor 220 instructing the processor 220 to lookup or use particular data stored in the memory 215 (e.g., a particular type of product). Thus, a user may instruct the processor 220 via the input device 205 what product is desired to be within the product container, and the processor 220 will interface with the sensor 210 and with the appropriate data in the memory 215 to determine accurate information about the product. Interfacing between any of the processor 220, the sensor 210, the memory 215, and/or the input device 205 may be performed wirelessly or by a wired connection.

In order to display or otherwise alert a user of this information, a display 225 is also connected to the processor 220. The display 225 may be a screen (e.g., an LCD screen), one or more lights (e.g., light-emitting diodes or other lamps), or any other type of visual indicator capable of providing information to the user. In alternative embodiments, other indications besides visual displays (e.g., audible) may be used. A transmitter 230 is also connected to the processor 220 so that the processor may interface or communicate with a remote device (e.g., a cell phone, a tablet, a computer, etc.) For example, if the processor 220 determines that a level or amount of product in the container is below a predetermined threshold, the processor 220 may send a signal to the remote device. In some embodiments, a receiver 235 may also be connected to the processor 220 for allowing the processor to receive data from the same or a different remote device.

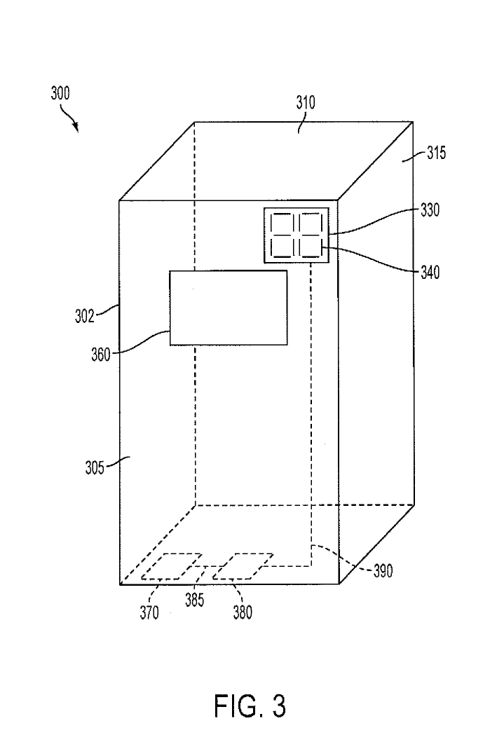

FIG. 3 shows a perspective view 300 of a product container or body 302 using electronic components to provide a visual indication of a characteristic of a product contained therein. The product container or body 302 may include the same or similar features as previously discussed. The product container or body 302 contains a volume therein for holding or containing an amount of a product. The product container 302 may be any type of food container or non-food container that is capable of holding a volume of a product within. As shown, the product container 302 has a front surface 305, a top surface 310, and a first side surface 315. A label 360 or other printing may be disposed upon the front surface 305 to indicate the type of product within the product container 302. While not visible in FIG. 3, the product container 302 may also have a rear surface opposing the front surface 305, a bottom surface opposing the top surface 310, and a second side surface opposing the first side surface 315. In an alternative embodiment, any of a variety of surfaces, shapes, or other forms or configurations of the product container 302 may be utilized. Moreover, the label 360 or other printing may be disposed on any of the variety of surfaces, shapes, or other forms or configurations of the product container 302 or may be omitted completely.

A visual indicator 330 is coupled with the front surface 315 of the product container 302. The visual indicator 330 includes a plurality of light segments 340 (e.g., light emitting diodes or other lamps) positioned so to form different numerals when certain of the light segments 340 are illuminated. Although two different numerical digits may be shown with the configuration of light segments 340 as shown in FIG. 3, an alternative embodiment may utilize greater or fewer numerical digits or light segments as desired. As discussed in greater detail below, the light segments 340 may be commanded or controlled so as to display information about the product contained within the product container 302.

A sensor 370 is coupled with the product container 302 on a bottom of the product container 302. In an alternative embodiment, the sensor 370 may be disposed on a variety of different locations on or in the product container 302. The sensor 370 is configured to determine or sense a characteristic of the product contained in the product container 302 (e.g., weight of the product, distance of the product from the sensor, etc.). The sensor 370 interfaces or communicates 385 with a processor 380. The processor 380 is also coupled with the product container 302 (e.g., on a bottom of the product container 302 as shown or on a variety of different locations).

The processor 380 uses the signal or data received from the sensor 370 to determine information about the product contained within the product container 302. For example, if the sensor detects that the product within the product container 302 currently weighs 1 pound, the processor 380 receiving such data from the sensor may calculate or otherwise determine the number of calories of product left in the product container 302 based upon the characteristic of the product sensed by the sensor 370. The visual indicator 330 communicates or interfaces 390 with the processor 380 in order to display or otherwise communicate the information about the product determined by the processor 380 to a user. For example, if the processor 380 determined 50 calories of product remained in the product container 302, the numerical digits “5” and “0” could be displayed by the visual indicator 330 based upon the communication or interfacing 390 with the processor 380.

In this manner, a characteristic of the product in the product container 302 that is sensed by the sensor 370, may be used to determine information about the product (e.g., calorie information, amount of product remaining in the product container 302, etc.) by the processor 380, and subsequently displayed in the visual indicator 330. A user may selectively determine which product information is most desired and communicate with the processor 380 to select or choose such information, for example, via a remote device communicating with the processor via wireless communication and/or via any other input device (wired or wireless). For example, a button, switch, knob, etc. may be coupled with the product container 302 and interface with the processor 380 for the user to manipulate in order to selectively choose the information desired to be viewed.

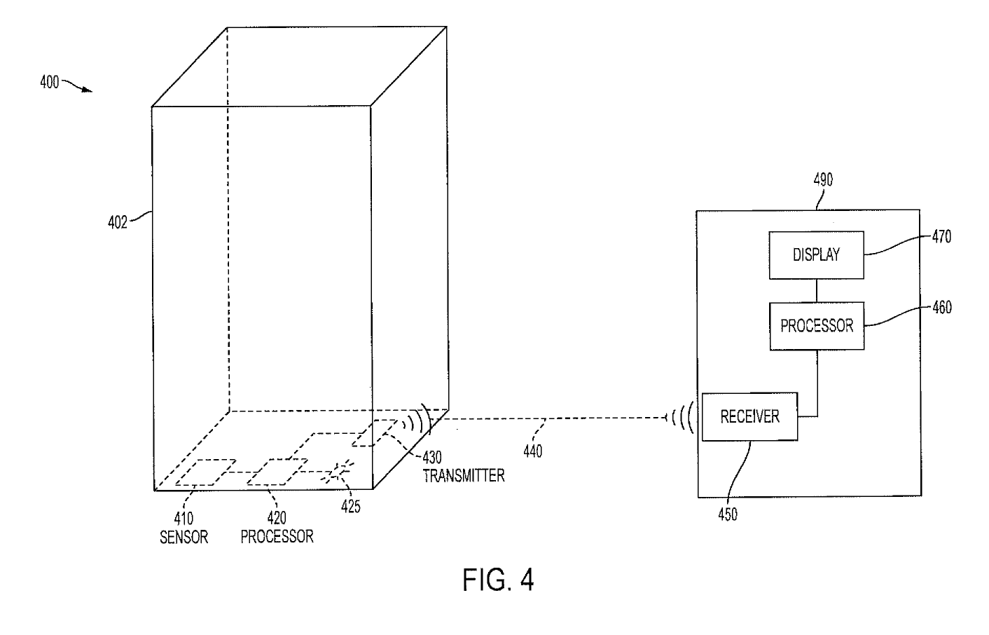

FIG. 4 shows a perspective view 400 of a product container or body 402 using electronic components to interface with a second device for providing an indication of a characteristic of a product contained within the product container. The product container or body 402 may include the same or similar features as previously discussed. For example, the product container 402 contains a volume therein for holding or containing an amount of a product and has a sensor 410 for sensing a characteristic of the product, a processor 420 in communication with the sensor 410 for determining information about the product based on the characteristic of the product sensed by the sensor 410 and a visual indicator 425 connected to the processor for displaying information about the product to a user.

A transmitter or antenna 430 is connected to the processor 420 for transmitting 440 data to a receiver 450 in a remote device 490, such as a mobile phone or computer. The remote device includes a processor 460 connected with the receiver 450 to receive the data transmitted 440 from the processor 420 of the product container 402. The remote device also includes a display 470 for displaying or otherwise indicating to a user the information about the product to a user. Thus, if the sensor 410 determines the product in the product container 402 weighs a particular amount, and the processor 420 determines this weight corresponds to a particular volume of product being within the product container, the display 470 of the remote device 490 may inform a user of this amount and/or that the product container 402 is getting low on product and needs to be repurchased. Thus, in certain embodiments, the remote device 490 may aid the user as a shopping tool (e.g., a grocery list that is automatically updated upon syncing by a user and/or on a predetermined schedule) by notifying the user when particular products need to be repurchased without the user needing to manually inspect each item in their cupboard or pantry.

The product container 402 may be a disposable container (e.g., cardboard) expected to be thrown away by the user when the product within runs out. In an alternative embodiment, the product container may be a more permanent container (e.g., plastic or Tupperware) that the user can refill with new product (either the same product or different product) when it empties. Although the product container 402 is shown having a box-like configuration with six sides, any number of sides may be used to make up the product container in an alternative embodiment. Moreover, any of a number of configurations or designs may be used in replacement of a box-like shape (e.g., tubular, spherical, etc.)

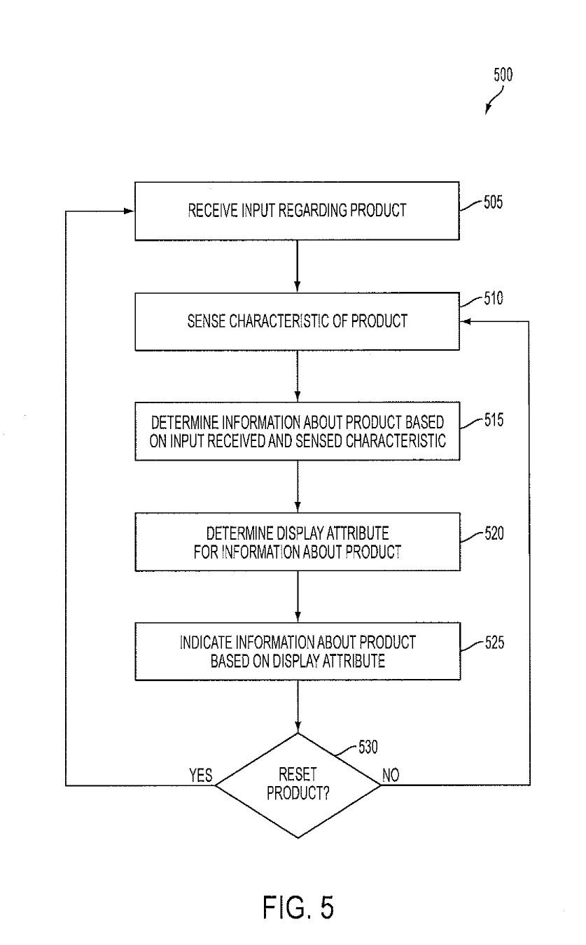

Turning lastly to FIG. 5, a flowchart 500 is shown for a method of indicating to a user information about a product contained within a product container. The product container may utilize a processor, a sensor, a memory, etc. as discussed above to perform one or more of the steps described herein. At step 505, a processor receives input regarding the product contained or to be contained within the product container. This may include, for example, a type of the product (e.g., cereal, rice, etc.). At step 510, a sensor senses a characteristic of the product contained within the product container. At step 515, a processor determines information about the product contained within the container based upon the input received in step 505 and the characteristic of the product sensed in step 510. For example, if the input received identifies the product type as cereal and the characteristic of the product sensed by the sensor is weight of the product, then the information determined about the product may be a volume or amount of product remaining in the product container, a number of calories for product remaining in the product container, etc.

At step 520, the processor determines a display attribute for the information about the product determined in step 515. For example, this may be the number of calories for product remaining in the product container, the number of calories already consumed of the product in the product container, the number of servings left or already consumed of product in the container, etc. In some embodiments, the determination of a display attribute in step 520 may be performed prior to the determination of information about the product described in step 515. At step 525, the information about the product determined in step 515 is indicated to a user (e.g., via a visual indicator like a light or an audible indicator like a chime) based upon the display attribute determined in step 520.

At step 530, if the processor determines that the product is to be reset (e.g., a user wishes to fill the product container with a different type of product), then operation continues back to step 505 where the processor receives new input regarding the product. If the product is not to be reset, then operation continues back to step 510 and a characteristic of the product contained within the product container is sensed by the sensor. Alternative embodiments may utilize greater or fewer steps than those described in the flowchart 500 of FIG. 5 and may arrange or order the steps in any desired operational order.

The previous description of the disclosed examples is provided to enable any person of ordinary skill in the art to make or use the disclosed methods and apparatus. Accordingly, the terminology employed throughout should be read in a non-limiting manner. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

What is claimed is:

1. A container comprising:
a body defining a cavity therein for containing a product, the body having a surface defining an opening; and
an indicator coupled with the body and configured to turn on based upon the amount of the product in the cavity.

2. The container of claim 1 wherein the indicator is a light-emitting diode.

3. The container of claim 1 further comprising a plurality of indicators arranged substantially in a line wherein each of the plurality of indicators is configured to turn on based upon the amount of the product in the cavity.

4. The container of claim 1 wherein the indicator is configured to turn on when the product is disposed adjacent to the indicator and to not turn on when the product is not disposed adjacent to the indicator.

5. A container comprising:
a body defining a volume therein for holding a product;
a sensor coupled with the body for sensing a characteristic of the product;
a processor configured to interface with the sensor; and
an indicator configured to interface with the processor for indicating information about the product based on the characteristic of the product sensed by the sensor.

6. The container of claim 5 wherein the processor is attached to the body.

7. The container of claim 5 wherein the indicator is attached to the body.

8. The container of claim 5 wherein the indicator comprises a plurality of light segments configured to illuminate to form numerals.

9. The container of claim 5 wherein the characteristic of the product sensed by the sensor is a weight of the product held within the volume defined by the body.

10. The container of claim 9 wherein the information about the product indicated by the indicator is an amount of the product held within the volume defined by the body.

11. The container of claim 9 wherein the information about the product indicated by the indicator is a level of the product held within the volume defined by the body.

12. The container of claim 9 wherein the information about the product indicated by the indicator is a number of calories of the product held within the volume of the body.

13. The container of claim 5 further comprising an antenna coupled with the processor for communicating with a remote device.

14. The container of claim 13 wherein the remote device is a mobile phone.

15. The container of claim 13 wherein the remote device is a network router.

16. The container of claim 5 wherein the processor is configured to receive input from a user.

17. A method for indicating to a user information about a product contained in a container, the method comprising the steps of:
sensing a characteristic of the product using a sensor;
determining, using a processor, an amount of the product contained in the container based on the sensed characteristic of the product; and
communicating to the user information about said amount of said product;

18. The method of claim 17 further comprising the step of receiving, at the processor, input about the product, the input identifying a type of the product.

19. The method of claim 17 wherein the step of communicating to the user information about said amount of said product further comprises:
determining a display attribute, using the processor, for indicating to the user the amount of the product contained in the container; and
indicating to the user the amount of the product contained in the container based on the display attribute.

20. The method of claim 17 wherein the step of communicating to the user information about said amount of said product comprises:
transmitting data to a remote device; and
displaying, using a display of the remote device, information about said product.
